(19) United States
(12) Patent Application Publication
(10) Pub. No.: US 2012/0065972 A1
(43) Pub. Date: Mar. 15, 2012

(54) WIRELESS VOICE RECOGNITION CONTROL SYSTEM FOR CONTROLLING A WELDER POWER SUPPLY BY VOICE COMMANDS

(75) Inventors: ANTON STRIFLER, EDMONTON (CA); JAMES BAKER, EDMONTON (CA)

(73) Assignee: VAR SYSTEMS LTD., EDMONTON (CA)

(21) Appl. No.: 12/880,105

(22) Filed: Sep. 12, 2010

(51) Int. Cl. G10L 17/00

(52) U.S. Cl. 704/246

(57) ABSTRACT

A wireless voice recognition control system for controlling the operation of an electric welder power supply by operator voice commands is disclosed. The system includes a remote module carried by the welder and a host module interfaced with the electric welder power supply. The remote module compares voice commands by the welder to preprogrammed voice command templates and operates to generate and broadcast a wireless signal when a spoken voice command matches a voice command template. The host module operates to receive the wireless signal and is configure to operate the electric welder power supply accordingly. In other embodiments, the host module and remote module operate to provide an audible feedback or acknowledgement to the welder. Other embodiments are also disclosed.

### FIELD OF THE INVENTION

The present invention relates generally to the remote control of welding power supplies, and more particularly, relating to a wireless voice recognition control system for the control of a welder power supply by voice commands.

### BACKGROUND OF THE INVENTION

The art of welding often requires the operator to select and adjust operating parameters which can be facilitated from the control panel of the welder power supply/engine machine. Some of the parameters can be more conveniently controlled by a remote control device. Numerous types of wired remote control devices are described in the patent literature ranging from cabled boxes containing potentiometers or rheostats to remote hand held, finger tip or foot controlled cabled controllers. The basic composition and operation of such remote control systems are well known in the art. For added convenience, such remote controls are generally designed to be sufficiently small and portable during operation.

Welder power supply machines are commonly used at construction sites, ship yards, mine sites and oil fields and it is not uncommon for the welder machines to be periodically relocated or surrounded by other mobile heavy equipment operating in the same worksite. As such, the remote cables can become damaged by being crushed or snagged from contact with surrounding machines and/or traffic. This can potentially cause damage to the welding power source if internal power conductors become shorted to signal leads that are connected to sensitive signal circuitry.

Wireless hand-held remote controllers improve upon the cabled remote controllers by eliminating the control cable between a battery operated remote module used by the welding operator and a host module that is attached and connected to the welder power supply. The small form factor control buttons and switches are difficult to operate with heavily padded welder's gloves. Furthermore, if a welder operator's hands are engaged in an activity, any interruption such as having to set aside the welding electrodes or torch in order to remove gloves to operate the hand-held remote control is an inconvenience and can have an adverse effect on productivity.

Voice command welder power supply control systems are also known in the art of welding. Rather than shout or issue radio voice commands to a human helper located at the welder power supply, the welder operator now has the ability to adjust the output settings of the welder power supply by using voice commands spoken into a microphone. However several problems exist with such a system.

The first problem with known voice command systems is the use of a traditional microphone or a push-to-talk microphone. Welding operations are often performed in areas with high levels of acoustic noise and electromagnetic interference. Traditional microphones have proven to be inconsistent when used in this application. Also, the frequency response of a standard microphone changes when incorporated into the helmet that is worn by the welder operator.

A further problem with using a throat microphone is that when the operator moves to re-position himself in relation to the work, the throat microphone may move changing its contact location and significantly altering its gain and frequency response. Standard voice recognition module technologies have a range of automatic gain control available but cannot accommodate the effects of microphone gain changes as well. If the amplitude is not in the active range of the requirements of the voice recognition module, then the reliability of voice recognition is severely degraded.

A further problem with bone conduction microphones is that they are not comfortable to wear for extended periods of time. Pressure must be maintained against the bone to maintain signal amplitude. Movement of the operator will often dislodge the bone conduction and the gain and frequency response will change so that the voice signals are no longer recognizable.

The best microphone technology from a consistent gain and frequency response, a comfortable fit to the operator, from rejection of ambient acoustic noise, and for suitability for wearing additional protective gear is the ear canal microphone. This type of microphone picks up sound from the inner ear that is conducted through the skull bones without having to press on the bone. The main problem with this type of microphone is that the signal levels are very low and a pre-amplifier is required to get signals comparable to an electric condenser type boom microphone.

A second problem with known wireless voice command control systems is that they are not bi-directional and the operator cannot ascertain if the voice command was received and acted upon.

A third problem is that an electric welding environment generates extreme electrical and radio frequency noise so reliable wireless communication is a problem. Other voice operated control systems have attempted to transmit the audio voice signal from the operator to a voice recognition system that is located at the host module. The reliability of streaming an audio signal in a high electrical noise environment is poor. There is a further penalty of high power consumption and short battery life when sending streams of data over a radio link.

A fourth problem is that severe electrical noise can also adversely affect the operation of the circuitry in the remote module.

A fifth problem with known wireless voice command systems is that they do not accommodate multiple welder control systems to operate in the same radio signal zone.

The patent literature contains and discloses related art however it should be noted that none of the prior art references cited below describe the unique enhancements and solutions to the art of voice activated control that are embodied by this invention.

U.S. Pat. No. 4,216,367 discloses a welding machine which can be remotely controlled by the human operator to provide a desired power level using a main rheostat. U.S. Pat. No. 4,266,114 discloses a portable regulating device intended to be connected into the welding current circuit between the electrode or electrode holder and the workpiece or clamp. U.S. Pat. No. 4,275,266 discloses a machine which responds to predetermined musical tones which are delivered in a coded sequence to generate a digital control output. U.S. Pat. No. 4,340,797 discloses a heating apparatus such as an electric oven which includes a voice recognition part capable of recognizing voice commands of the user. U.S. Pat. No. 4,641,292 describes a general application of voice control but requires a PC computer for operation.

Additional problems are addressed by the art for various remotely controlled consumer appliances, where each is typically supplied with a separate remote control transmitter. As the number of separate remote control transmitters increase, locating, distinguishing, and locating the appropriate transmitters becomes increasingly difficult. In response to this problem, universal remote control transmitters, pre-programmed by the manufacturers with control commands, typically coded infrared signals, have been developed to operate many different remotely controlled electronic appliances, for example, as disclosed in U.S. Pat. No. 4,774,511. In addition to universal remote control transmitters, learning remote control transmitters have been developed which receive the control command signals, typically infrared codes, from the remote control transmitters provided with remotely controlled appliances and generally store the frequencies and pulses into memory, with the signals becoming associated with buttons located on the keypad of the learning remote control transmitter. After programming is complete, depressing the keypad buttons prompts the learning remote control transmitter to re-transmit the codes stored within its memory. This allows the user to consolidate the control of several remotely controllable appliances into a single handheld remote control transmitter. An example of such a system is disclosed in U.S. Pat. No. 5,142,398. For additional convenience to the user, the learning capability has been combined with universal remote control transmitters which are pre-programmed by the manufacturers with control commands necessary to operate many different remotely controlled electronic appliances, for example as disclosed in U.S. Pat. No. 5,691,710. All of the above-mentioned systems require the user to establish physical contact, typically in the form of manually depressing keypad buttons, to transmit a control command to the remotely controlled appliance. As such, the above-mentioned systems due to their small size are often misplaced causing frustration to the user.

U.S. Pat. Nos. 5,199,080; 5,226,090, 5,247,580; 5,267,323 and 5,226,090, disclose various embodiments of voice-operated remote control systems which employ voice control commands instead of control commands entered through buttons on a keypad. Unfortunately, such systems are not truly hands-free, requiring manual intervention by the user during use. In particular, such remote control systems as disclosed in the above-mentioned patents, are all based upon the use of a “talk switch”; which must be manually depressed to enter a voice command when the transmission of a remote control signal is desired.

Various other systems are known which use speech recognition to control appliances. For example, U.S. Pat. No. 5,852,804 discloses a system for controlling several external appliances connected to a speech recognition system. However, the system requires physical interconnections between the control system and the appliance which makes it difficult for a user to add additional appliances or change controlled appliances.

U.S. Pat. No. 5,878,394 discloses a system which includes connections to a remote control network for transmitting infrared codes and a graphical user interface on a personal computer (PC). U.S. Pat. No. 5,774,859 discloses a subscriber information system with a speech interface, similar to the system disclosed in U.S. Pat. No. 5,878,394 and is likewise based upon a PC-class processor. Operation of this system is dependent upon receiving information from an information distribution center or head-end installation and therefore lacks the advantages of a stand-alone device. The remote control is not capable of independently completing the speech recognition process and transmitting infrared signals indicated by such recognition results to controlled appliances and requires a PC-class processor.

U.S. Pat. No. 6,103,994 describes a fingertip/foot control device cabled remote control device. U.S. Pat. No. 6,570,134 relates to a method of exchanging data between a remote control unit and a welder power supply. The system is based on electronic feedback circuitry which controls the welding system through the transmission of signals across a welding cable. U.S. Pat. No. 6,815,640 discloses a system to reconfigure welding power supply. U.S. Pat. No. 6,895,380 describes a voice activated control system with contextual learning and adaptive command predictor algorithms.

U.S. Pat. No. 7,080,014 B2 Discloses a hands free voice operated remote control device for appliances and various manufacturing machines. U.S. Pat. No. 7,381,922 describes an apparatus for remotely controlling a welding system through the transmission of control signals across a welding cable. The system is based on electronic feedback control circuitry which requires the periodic disabling of the power output in order to receive and transmit control commands across the cable. This can be a disadvantage because it disrupts the work flow in order to reset the welder output controls.

Thus there is a need for an improved voice recognition system that is wireless, portable, welding operator specific, and functions reliably in very high ambient electrical and acoustic noise environments to allow a user to quickly and safely adjust the power output of the welder power supply located some distance from the welding operation.

### SUMMARY OF THE INVENTION

Embodiments of the present invention addresses this need by providing an apparatus including a battery operated portable remote module carried on the operator and a host module that is connected to an electric welder power supply's hard-wired remote control port. A microphone is attached to the remote module to accept voice commands from the welder operator. The remote module contains a voice recognition module that will recognize pre-programmed voice commands and act on those commands to adjust a setpoint level for the output current or power of the welder power supply.

When a change in setpoint is requested, a wireless radio frequency transceiver will send the setpoint value to the host module and receive a confirmation from the host that the communication was successful. The host will then adjust its output control signal to the welder power supply to effect the change and the remote module will provide audio feedback to the operator that the adjustment was successful.

Embodiments of the present invention also provide several improvements in microphone application technology to address the high ambient acoustic noise as follows: 1. use a noise cancelling microphone to increase the spoken sound signal to ambient noise ratio; 2. use a throat microphone that picks up sound through the neck rather than air-borne sound; 3. use a bone conduction microphone that picks up sound signals through the temple (skull) bone; 4. use an ear-bone conduction microphone that picks up sound signals through an in-ear contact with the ear canal bone; and 5. use an ear canal microphone (ear-bud transducer) that picks up sound from inside the ear canal without pressing on the bone.

Microphone types 2, 3, 4, and 5 have better ambient noise rejection in the order listed. These types of microphone are also more suitable if the welder operator must wear additional protective gear such as a dust or vapor mask. It is known that the gain and frequency response of microphone types 2, 3, 4, and 5 above are not the same as a standard microphone receiving air-borne sound. The signal amplitude available from microphone types 2, 3, 4, and 5 are also lower than from a standard microphone.

Embodiments of the present invention also provide full loop feedback that includes the wireless communication link. When a voice command is recognized by the voice recognition module, the appropriate change in setpoint value is made, the new setpoint value is transmitted from the remote module to the host module, the host module successfully receives the new setpoint value, the host module provides an acknowledgement back to the remote module on the wireless path, the remote module correctly receives the acknowledgement, then an audio feedback is provided to the operator. This feedback loop to confirm that the command was processed successfully occurs within one-half second so that the feedback is essentially in real-time.

Embodiments of the present invention also mitigate the electrical interference problem through programmed retries, using very short data packets, using check-sums on the data packet that is being transmitted to ensure that the data transmitted is valid, and returning an acknowledgement message back to the Remote when the information was received successfully. In the present invention, the power consumption is minimized by sending short packets of data only when a change in setpoint is required.

Embodiments of the present also provides for three layers of “watchdog” operation along with automatic restarting and automatic resuming of the voice recognition module and the communication module if it is self-determined to not be working properly.

Embodiments of the present invention also provide for the operation of multiple welder control systems to operate in the same radio signal zone permit operation by only transmitting a short packet of data whenever a setpoint change is made and does not attempt to send a continuous stream of data. The data packet contains a unique address of the host module and the remote module that is allowed to work together. Other pairs of host and remote modules can operate in the same radio signal zone and on the same base frequency channel because they will only respond to packets of data that specifically addressed to each other. The present invention has a method to identify which remote module is to control which host module at the time that both modules are powered up. Even with short packets of data being communicated, the present invention incorporates protocols for collision avoidance by not starting a transmission if there is radio frequency activity on the channel and by performing retries if the data did not get acknowledged by its intended recipient.

To achieve these and other advantages, in general, in one aspect, a wireless voice recognition control system for the control of an electric welder power supply by voice commands is provided. The system includes a remote module for use by a welding operator. The remote module includes a voice input device operating to receive a voice input from the welding operator and to generate a voice signal, a voice recognition processor operating to receive the voice signal and to compare the voice signal against one or more stored voice command templates, the voice recognition processor further operating to generate a control signal when the voice signal matches a stored voice command template, and a remote module transceiver operating to receive the control signal and to wirelessly broadcast the control signal. The system further includes a host module. The hose module includes a host module transceiver operating to receive the control signal, and a host module microcontroller operating to receive the control signal from the host module transceiver and to generate an output control signal configured to control a function of the welder power supply, whereby the electric welder power supply is configured to receive the control signal.

In general, in another aspect, the host module microcontroller further operates to generate an acknowledgement signal. The host module transceiver further operates to receive the acknowledgement signal and to wireless broadcast the acknowledgement signal. The remote module transceiver further operates to receive the acknowledgement signal from the host module transceiver, and the voice recognition processor further operates to receive the acknowledgement signal from the remote module transceiver and to generate an audio acknowledgement signal. An output device operates to receive the audio acknowledgement signal from the voice recognition processor and to generate an audible sound which provides audio feedback to the welding operator.

In general, in another aspect, the system further includes one or more transducers operable in either an input mode to receive the voice input or an output mode to output the audio acknowledgement signal. The voice input device comprising one of the transducers. The output device comprising one of the transducers. The remote module further includes a multiplexer switch operable to selectively connect the one or more transducers to an interface circuit of the remote module or to an audio amplifier circuit of the remote module.

In general, in another aspect, the system further includes a remote module microcontroller operating to monitor activity of the voice recognition processor and operating to reset and re-initialize the voice recognition processor if the activity is determined to be abnormal.

In general, in another aspect, a wireless voice recognition control system for the control of a welder power supply by voice commands is provided. The system includes a remote module operating to receive and process a voice signal from a voice input device and to broadcast a control signal in accordance with the voice signal, a host module operating to receive and process the control signal and generate a welder power supply control signal in accordance with the voice signal, and the host module and the remote module each having a unique address and each operating to only communicate with each other in accordance with the unique addresses.

In general, in another aspect, the system further includes a voice input device operating to receive a voice input from the welding operator and to generate a voice signal and a voice recognition processor operating to receive the voice signal and to compare the voice signal against one or more stored voice command templates. The voice recognition processor further operating to generate a control signal when the voice signal matches a stored voice command template. A remote module transceiver operates to receive the control signal and to wirelessly broadcast the control signal. The host module includes a host module transceiver operating to receive the control signal. A host module microcontroller operates to receive the control signal from the host module transceiver and to generate an output control signal configured to control a function of the welder power supply. The host module transceiver further operates to receive the acknowledgement signal and to wireless broadcast the acknowledgement signal. The remote module transceiver further operates to receive the acknowledgement signal from the host module transceiver. The voice recognition processor further operates to receive the acknowledgement signal from the remote module transceiver and to generate an audio acknowledgement signal. An output device operates to receive the audio acknowledgement signal from the voice recognition processor and to generate an audible sound which provides audio feedback to the welding operator.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a diagrammatic view of a wireless voice recognition control system for the control of a welder power supply by voice commands constructed in accordance with the principles of the present invention;

FIG. 2 is a block diagram of a Remote module of the system of FIG. 1;

FIG. 3 is a block diagram of a Host module of the system of FIG. 1;

FIG. 4 is a diagrammatic view of an alternative embodiment of the system of FIG. 1; and

FIG. 5 is a diagrammatic view of an alternative embodiment of the system of FIGS. 1 and 4.

### DETAILED DESCRIPTION OF THE INVENTION

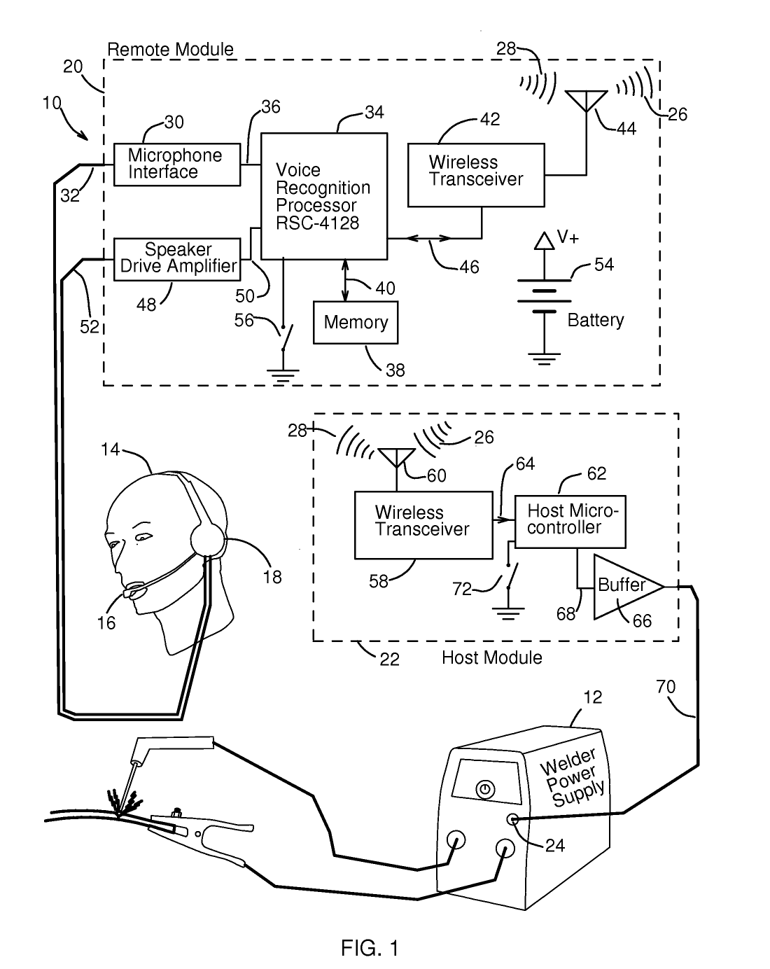

In FIG. 1 there is diagrammatically shown a voice recognition control system 10 for the wireless control of a welder power supply 12 by voice commands spoken by an operator 14. System 10 provides an operator 14 with the hands free and wireless control of the welder power supply 12 permitting the operator to continuously focus on a welding operation. System 10 comprises an operator voice input device 16 and an operator audio output device 18, depicted here as a boom microphone and an over-ear headset, respectively. As it will later be discussed, the input device 16 and the output device 18 device may include several alternatives to microphone 16 and headset 18. System 10 further comprises a Remote module 20 carried by the operator 14, and a Host module 22 that is interfaced with a conventional remote control port 24 of the welder power supply 12. A welder power supply 12 may be, but is not limited to a Lincoln Ranger model 250GTX.

Broadly, the remote module 20 operates to receive a voice command input from the operator 14 via voice input device 16 and to broadcast a wireless control signal 26 via antenna 44 that is received by the host module 22 via antenna 60. The host module 22, in accordance with the received wireless control signal 26, generates an output control signal that is configured to be received by the welder power supply 12 via remote control port 24. The welder power supply 12 then performs a function or process in accordance with the original voice command input.

In embodiments, the host module 22 can operate to generate an acknowledgment signal to acknowledge that the command signal was correctly received and to broadcast a wireless acknowledgement signal 28 via antenna 60 that is received by the remote module 20 via antenna 44. The remote module 20, upon receiving the acknowledgement signal, will generate and output an audio acknowledgement signal via the audio output device 18, and thus, providing an audible confirmation to the operator 14 that the command signal 26 was received by the host module 22.

With continued reference to FIG. 1, in an embodiment, the remote module 20 includes an interface circuit 30 to which the operator input device 16 is operatively connected by interconnect 32. The interface circuit 30 is operatively connected to a voice recognition processor 34 such as, but not limited to a Sensory Inc. voice recognition processor product number RSC2148, by interconnect 36. A memory device 38 is operatively connected to the voice recognition processor 34 by interconnect 40. A remote module transceiver 42 including antenna 44 is operatively connected to the voice recognition processor 34 by interconnect 46. A speaker drive amplifier circuit 48 is operatively connected to the voice recognition processor 34 by interconnect 50 and to the operator output device 18 by interconnect 52. A power supply such as battery 54 is provided to power the above described components of the remote module 20. A power switch 56 is provided to turn remote module 20 on and off.

Maintaining reference to FIG. 1, in an embodiment, the host module 22 includes remote module transceiver 58 including an antenna 60 operatively connected to a host module microcontroller 62 by interconnect 64. A welder control interface circuit 66 is operatively connected to the host module microcontroller 62 by interconnect 68 and to the welder power supply 12 via remote control port 24 by cable 70. The host module 22 is powered by the welder power supply 12 via remote control port 24. A power switch 72 is provided to turn the host module 22 on and off.

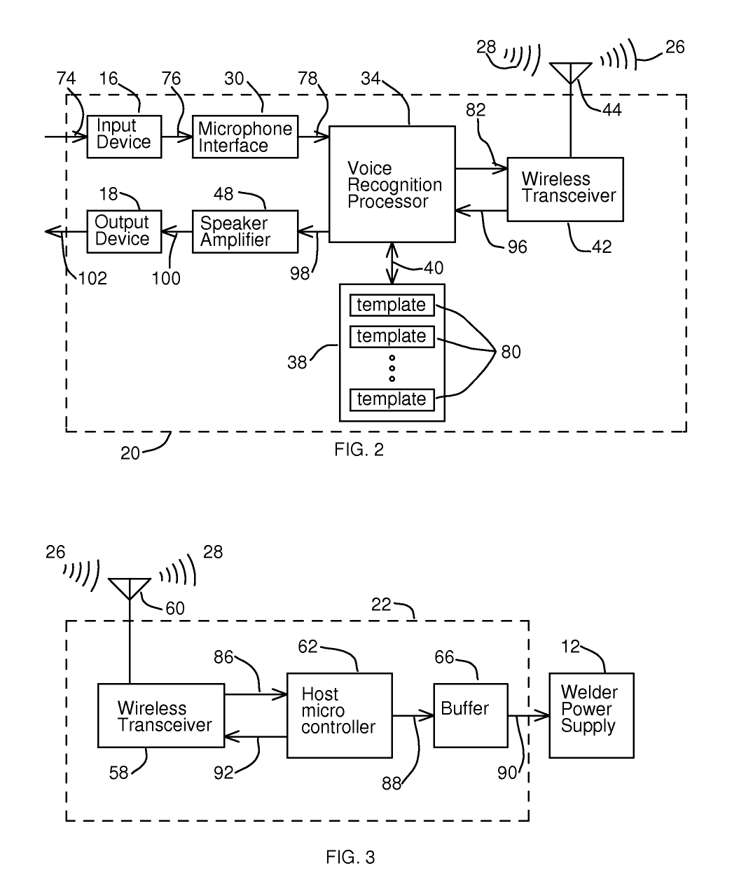

With reference to FIG. 2, input device 16 operates to receive a spoken voice 74 from an operator and to convert the voice input into analog voice signal 76. The interface circuit 30 operates to receive voice signal 76 and to generate a filtered and conditioned analog voice signal 78. Interface circuit 30 may include analog processing circuitry including gain control and frequency band filtering as part of an input stage to the voice recognition processor 34. Voice signal 78 is received by the voice recognition processor 34 where it is processed and compared against a set of voice command templates 80 programmed and stored in template memory 38. The method of programming the voice command templates is an aspect that is specific to the firmware and recognition algorithm used in the voice recognition processor and the functions are provided by the supplier of the voice recognition processor.

When the voice recognition processor 34 matches a voice command within the voice signal 78 with a stored voice command template 80, the voice recognition processor 34 determines if a previously stored setpoint value is to be changed in accordance with the matched voice command template. The setpoint value can be a percent of full scale current of the welder power supply 12. Some welder power supplies have an adjustable maximum for full scale current. If it is determined the setpoint value is changed, the voice recognition processor 34 generates a control signal 82 incorporating the new setpoint value and stores the new setpoint value. The control signal 82 is received by the remote module transceiver 42 and is broadcasted via antenna 44 as a wireless control signal 26.

Turning to FIG. 3, the wireless control signal 26 is received at the host module 22 by host module transceiver 58 via antenna 60. Host module transceiver 58 operates to convert the wireless control signal 26 into control signal 86, which is essentially the same as control signal 82 from FIG. 2. Host module microcontroller 62 receives control signal 86 and based upon the setpoint value contained therein generates an analog output control signal 88 comprising a voltage signal of between 0 and 10 volts. This can be accomplished with a digital-to-analog converter such as a pulse width modulated signal that has a low pass filter applied. Output control signal 88 is received by welder supply interface circuit 66 where it is amplified and buffered to meet the input requirements of the welder remote control port 24 and is outputted as output control signal 90 and received by the welder power supply 12.

Maintaining reference to FIG. 3, in an embodiment, the host module 22 may operate to acknowledge the reception of control signal 26. In this manner, upon receiving control signal 86, the host module microcontroller 62 generates a digital acknowledgement signal 92, which is received by the host module transceiver 58 and broadcasted via antenna 60 as a wireless acknowledgement signal 28. The wireless acknowledgement signal 28 is received by remote module transceiver 42 and converted into acknowledgment signal 96, FIG. 2. Acknowledgment signal 96 is received and processed by voice recognition processor 34 and outputted as audio signal 98. Audio signal 98 is amplified by speaker amplifier circuit 48 and outputted as an amplified audio signal 100 to operator output device 18 where it is converted into an audible sound 102 that can be heard and interpreted by the operator 14.

The audible sound 102 can be a short duration chirp sound, either an up-chirp or a down-chirp as related to increasing or decreasing the setpoint value. The short duration audio acknowledgement allows the system 10 to quickly return to listening for additional spoken voice commands, which allows for commands to be placed close together in time—the objective being to allow commands to be repeated quickly if necessary.

Example voice commands include: UP—will increase the setpoint value by one increment; UPFIVE—will increase the setpoint value by 5 increments; DOWN—will decrease the setpoint value by one increment; DOWNFIVE—will decrease the setpoint value by 5 increments; STANDBY—will store the present setpoint value in memory 38 but send a zero setpoint value to the host module 22 to turn off the welder power supply 12; and RESUME—the last known setpoint value is retrieved from memory 38 and sent to the host module 22.

In an embodiment, all un-necessary commands are inhibited to improve system response time and to minimize voice command detection errors. For example, once in STANDBY, the only command that is listened for is RESUME.

In other embodiments, more or fewer command words could be used and the choice of words can be changed. For most reliable operation with the Sensory Inc. voice recognition processor, the command words are more reliable if they are two syllables and as different sounding as possible. However, this may vary according the voice recognition processor that is employed with the system 10 described herein.

In an embodiment, when the RESUME or STANDBY commands are used, voice messages as to the present setpoint value, a message to say if the communication link between the remote module 20 and the host module 22 is working, and/or a message reporting the remaining battery capacity of power supply 54 can be played to the operator via audio output device 18. Other messages reporting various conditions or status of the system 10 and welder power supply 12 are possible.

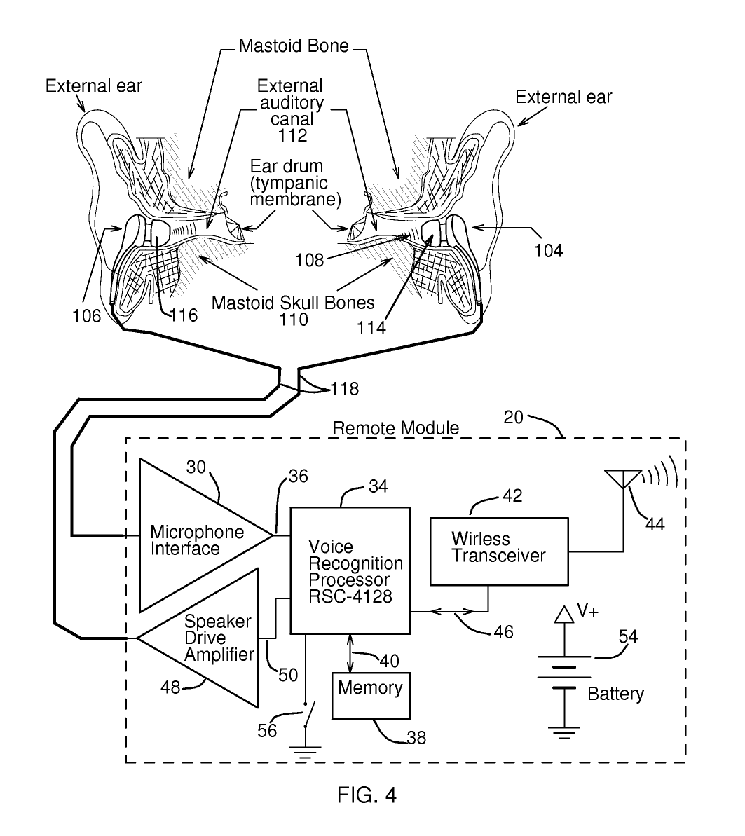

Turning to FIG. 4, there is diagrammatically shown an alternative embodiment where the operator input device 16 and the operator output device 18 are each an ear-bud transducer 104 and 106, respectively. Transducer 104 acts as a microphone and transducer 106 acts as a speaker. In this embodiment, transducer 104 takes advantage of the physical phenomena that during speaking there is a sound 108 emanating from skull bones 110 into the ear canal 112. Sound 108 can be received by transducer 104 that is sensitive to air-borne sound positioned within ear canal 112. Transducers 104, 106 can include a flexible seal 114, 116, respectively, that reduces ambient noise from entering the ear canal 112 which helps considerably to improve the acoustic signal to noise ratio. Advantages of using transducers 104 and 106 that are positioned within respective ear canals include the retention of positioning of the transducers when the operator moves about, the ability to use over-the-ear hearing protection, and the ability to use a face mask for protection from dust or vapor. Additionally, the use of transducers 104 and 106 provide a more consistent sound level from one use to the next so the command templates will not require re-training as often. Again, the training of templates is specific to the Voice Recognition Processor used and the detail for implementing such training is provided by the processor manufacturer.

The use of an in-ear transducer such as 104 as a microphone requires the microphone interface circuit 30 to amplify the low signal level generated by the transducer 104 to provide signal levels in the range that would be generated by conventional electric condenser microphones. Additional electrical noise reduction can be achieved by using twisted-pair shielded wire 118 between transducer 104 and interface circuit 30. Interface circuit 30 can also provide frequency filtering to emphasize the frequencies of interest for the voice recognition processor 34. It may be desirable to emphasize frequencies between 300 hz and 6000 hz depending upon the voice recognition processor 34. In an embodiment, the interface circuit 30 includes a low noise preamplifier with midband gain of 100 and a bandpass of 200 hz to 8000 hz.

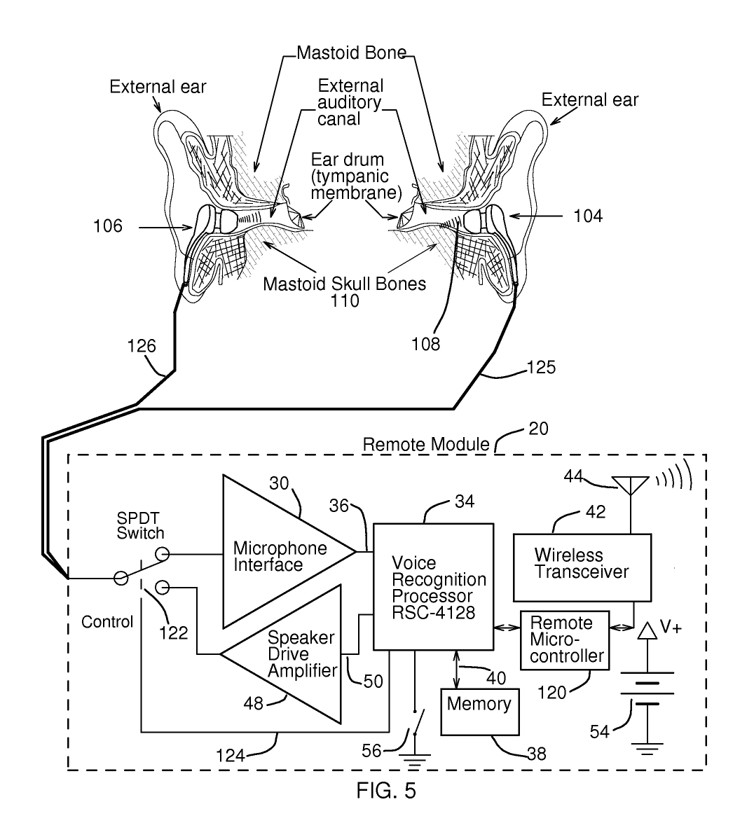

In FIG. 5, there is diagrammatical shown yet another alternative and more sophisticated embodiment where transducers 104 and 106 each operate as a microphone and as a speaker, where voice recognition processor 34 is capable of interfacing external hardware, and where a remote microcontroller 120 is included and provides additional functional features to the system 10. Transducers 104 and 106 are each operatively connected to a SPDT multiplexer switch 122, which operates to selectively couple transducers 104 and 106 to either the interface circuit 30 or the speaker drive amplifier circuit 48. Multiplexer switch 122 is operatively connected to voice recognition processor 34 by interconnect 124. Transducers 104 and 106 could be connected in series or parallel to multiplexer switch 122. As shown, the transducers 104 and 106 are connected in parallel so that shielded twisted-pair wire 125 and 126 can be used to reduce electrical noise.

In this embodiment, the voice recognition processor 34 is provided by the manufacturer with firmware and functions that allow for various modes of operation. Further, the voice recognition processor 34 is provided with programming space to customize the operation of the processor to allow interfacing with external hardware. A suitable voice recognition processor is available from Sensory Inc. as model RSC4128. However, alternative voice recognition processors could be employed. In an aspect, the voice recognition processor 34 is programmed to operate the multiplexer switch 122 to selectively connect the transducers 104 and 106 to either the interface circuit 30 or the speaker drive amplifier circuit 48 depending upon the operating state of the voice recognition processor. For example, when the voice recognition processor 34 is operating in a listening mode where speech spoken by the operator is being processed, the multiplexer switch 122 is switched to connect the transducers 104 and 106 to the interface circuit 30. Further, as an example, when the voice recognition processor 34 is operating in a reporting mode where status or condition reports are being played to the operator, the multiplexer switch 122 is switched to connect the transducers 104 and 106 to the speaker drive amplifier circuit 48.

Remote module microcontroller 120 is connected to and between the voice recognition processor 34 and the transceiver 42. Remote module microcontroller 120 is programmed to provide setup and control of transceiver 42, monitor the voltage of battery 54, process operator switch 56 that is used to power the remote module 20 ON and OFF, and process switch button presses during voice training mode, among other features.

Remote module microcontroller 120 also performs “watchdog” monitoring of the voice recognition processor 34. If remote module microcontroller 120 determines that the normal activity of the voice recognition processor 34 has stopped, the remote module microcontroller will reset and re-initialize the voice recognition processor and resume its operation where it was last determined to be functioning correctly. In more detail, the voice recognition processor 34 is programmed to report the setpoint value to the remote module microcontroller 120 at a repeating time interval, for example, every 30 seconds. If the remote module microcontroller 120 does not receive a report from the voice recognition processor 34 within the repeating time interval, it is assumed the voice recognition processor is not operating correctly and needs to be reset and re-initialized.

Remote module microcontroller 120 may also verify that a wireless communication channel is available and working between the remote module 20 and the host module 22. If the wireless communication between fails and cannot be re-initiated, then the remote module microcontroller 120 communicates this status to the voice recognition processor 34, which then operates to play a voice message or other audible reporting message to the operator communicating the status of the wireless communication.

Remote module microcontroller 120 may also be programmed to self-monitor its own activity similar to the “watchdog” function it provides on the voice recognition processor 34. The self-monitoring aspect may have a shorter repeating time interval than for monitoring the voice recognition processor 34. If the remote module microcontroller 120 determines that it is not operating correctly, it will automatically initiate a reset and restart.

It is contemplated that several voice recognition control systems may be employed in an area where the radio frequency generated by each control system will be detected by other control systems. Accordingly, in embodiments, the remote module 20 and the host module 22 have a unique addressable identifier such as, but not limited to a 16 bit binary address. In aspects of the system 10, short data packets are used in the wireless communication between the remote module 20 and the host module 22 to ensure communication reliability and to allow for additional systems 10 to operate in the same radio carrier frequency. Accordingly, wireless command signal 26 includes a data packet having the following content: destination address (the unique address of the host module 22 connected to the welder power supply); a sender address (the unique address of the remote module 20 in use by the operator); setpoint value (the percentage of full scale desired to set the welder power supply power level); and a check-sum (calculated on the above byte values to use as a packet quality confirmation). Additional data may be used to frame the data packet. Likewise, wireless acknowledgement signal 28 includes a data packet having the following content: destination address (the unique address of the remote module 20 in use by the operator); sender address (the unique address of the host module 22 connected to the welder power supply); full-scale value (the full scale value of the welder power supply); and a check-sum (calculated on the above byte values to use as a packet quality confirmation).

A method of linking a specific remote module 20 to a specific host module 22 is also provided. The host module 22 is initialized by powering ON the host module at which time the host module enters into a “listening mode” for a predetermined time period. In an embodiment the host module 22 will enter the listening mode for a period of 10 seconds after being powered ON. In the listening mode, the host module 22 is listening for a “universal broadcast” from a remote module 20 to establish a communication link with the remote module. The remote module 20 is initialized by powering ON the remote module within the time period which the host module 20 is in the listening mode. On powering of the remote module 20, the remote module broadcasts the universal broadcast. The universal broadcast includes a data packet having a special host destination address and the unique address of the remote module.

If the host module 22 receives a universal broadcast from a remote module 20 within the specified time period, the host module will respond by broadcasting a reply data packet including the unique address of the host module and will store the unique address of the remote module 20 in memory. Upon receiving the reply data packet from the host module 22, the remote module 20 will store the host module's unique address in its memory. Future data packets sent by the remote module 20 will be addressed to the now linked host module 22, and future data packets sent by the host module 22 will be addressed to the linked remote module 20. The linked host module 22 and remote module 20 will only accept and respond to communication from each other, and ignore communications from other remote module and host module pairs.

If the host module 22 does not receive a universal broadcast from a remote module 20 within the specified time period, or if the remote module 20 does not receive a reply data packet from the host module within the specified time period both the host module and the remote module will attempt to communicate with the last known address stored in memory. If the communication is successful, then the host module 22 and remote module 20 will again only accept communication from each other.

In other embodiments it is contemplated the host Module 22 could be integral with the welder power supply 12 as opposed to be interfaced with the welder power supply via the wired control port 24.

A number of embodiments of the present invention have been described. Nevertheless, it will be understood that various modifications may be made without departing from the spirit and scope of the invention. Accordingly, other embodiments are within the scope of the following claims.

What is claimed is:

1. A wireless voice recognition control system for the control of an electric welder power supply by voice commands, the system comprising:
a remote module for use by a welding operator, said remote module including:
a voice input device operating to receive a voice input from the welding operator and to generate a voice signal;
a voice recognition processor operating to receive said voice signal and to compare said voice signal against one or more stored voice command templates, said voice recognition processor further operating to generate a control signal when said voice signal matches a stored voice command template;
a remote module transceiver operating to receive said control signal and to wirelessly broadcast said control signal;
a host module, said host module including:
a host module transceiver operating to receive said control signal;
a host module microcontroller operating to receive said control signal from said host module transceiver and to generate an output control signal configured to control a function of the welder power supply, whereby said electric welder power supply is configured to receive said control signal.

2. The system of claim 1, wherein said remote module further includes:
an interface circuit coupling said voice input device and said voice recognition processor.

3. The system of claim 1, wherein:
said host module microcontroller further operating to generate an acknowledgement signal;
said host module transceiver further operating to receive said acknowledgement signal and to wireless broadcast said acknowledgement signal;
said remote module transceiver further operating to receive said acknowledgement signal from said host module transceiver;
said voice recognition processor further operating to receive said acknowledgement signal from said remote module transceiver and to generate an audio acknowledgement signal; and
an output device operating to receive said audio acknowledgement signal from said voice recognition processor and to generate an audible sound which provides audio feedback to said welding operator.

4. The system of claim 3, wherein said remote module further includes:
an audio amplifier circuit to drive said output device with said audio acknowledgement signal; and
an interface circuit coupling said voice input device to said voice recognition processor.

5. The system of claim 3, further comprising:
one or more transducers operable in either an input mode to receive said voice input or an output mode to output said audio acknowledgement signal;
said voice input device comprising one of said transducers;
said output device comprising one of said transducers; and
said remote module further including a multiplexer switch operable to selectively connect said one or more transducers to an interface circuit of said remote module or to an audio amplifier circuit of said remote module.

6. The system of claim 5, further comprising:
a remote module microcontroller operating to monitor activity of said voice recognition processor and operating to reset and re-initialize said voice recognition processor if said activity is determined to be abnormal.

7. The system of claim 3, further comprising:
a remote module microcontroller operating to monitor activity of said voice recognition processor and operating to reset and re-initialize said voice recognition processor if said activity is determined to be abnormal.

8. The system of claim 1, further comprising:
a remote module microcontroller operating to monitor activity of said voice recognition processor and operating to reset and re-initialize said voice recognition processor if said activity is determined to be abnormal.

9. A wireless voice recognition control system for the control of a welder power supply by voice commands, the system comprising:
a remote module operating to receive and process a voice signal from a voice input device and to broadcast a control signal in accordance with said voice signal;
a host module operating to receive and process said control signal and generate a welder power supply control signal in accordance with said voice signal;
and said host module and said remote module each having a unique address and each operating to only communicate with each other in accordance with said unique addresses.

10. The system of claim 9, wherein said host module further operating to generate and broadcast an acknowledgement signal; and
wherein said remote module further operating to receive and process said acknowledgement signal and output an audio signal to an output device.

11. The system of claim 10, wherein said remote module includes a voice input device operating to receive a voice input from the welding operator and to generate a voice signal, a voice recognition processor operating to receive said voice signal and to compare said voice signal against one or more stored voice command templates, said voice recognition processor further operating to generate a control signal when said voice signal matches a stored voice command template, a remote module transceiver operating to receive said control signal and to wirelessly broadcast said control signal;
wherein said host module includes a host module transceiver operating to receive said control signal, a host module microcontroller operating to receive said control signal from said host module transceiver and to generate an output control signal configured to control a function of the welder power supply;
wherein said host module transceiver further operating to receive said acknowledgement signal and to wireless broadcast said acknowledgement signal;
said remote module transceiver further operating to receive said acknowledgement signal from said host module transceiver;
said voice recognition processor further operating to receive said acknowledgement signal from said remote module transceiver and to generate an audio acknowledgement signal; and
an output device operating to receive said audio acknowledgement signal from said voice recognition processor and to generate an audible sound which provides audio feedback to said welding operator.

12. The system of claim 11, further comprising:
one or more transducers operable in either an input mode to receive said voice input or an output mode to output said audio acknowledgement signal;
said voice input device comprising one of said transducers;
said output device comprising one of said transducers; and
said remote module further including a multiplexer switch operable to selectively connect said one or more transducers to an interface circuit of said remote module or to an audio amplifier circuit of said remote module.

13. The system of claim 12, further comprising:
a remote module microcontroller operating to monitor activity of said voice recognition processor and operating to reset and re-initialize said voice recognition processor if said activity is determined to be abnormal.

14. The system of claim 11, further comprising:
a remote module microcontroller operating to monitor activity of said voice recognition processor and operating to reset and re-initialize said voice recognition processor if said activity is determined to be abnormal.

15. The system of claim 10, further comprising:
a remote module microcontroller operating to monitor activity of said voice recognition processor and operating to reset and re-initialize said voice recognition processor if said activity is determined to be abnormal.

16. The system of claim 9, further comprising:
a remote module microcontroller operating to monitor activity of said voice recognition processor and operating to reset and re-initialize said voice recognition processor if said activity is determined to be abnormal.
